(19) United States
(12) Patent Application Publication
(10) Pub. No.: US 2023/0059447 A1
(43) Pub. Date: Feb. 23, 2023

(54) TRAINING DEVICE, PLANT, METHOD OF GENERATING MODEL, INFERENCE DEVICE, INFERENCE METHOD, AND METHOD OF CONTROLLING PLANT

(71) Applicants: Preferred Networks, Inc., Tokyo (JP); ENEOS CORPORATION, Tokyo (JP)

(72) Inventors: Kaizaburo KIDO, Tokyo (JP); Taichiro HIRAI, Tokyo (JP); Kosei KANUMA, Tokyo (JP); Hiroyuki HINO, Tokyo (JP); Dai YONEDA, Tokyo (JP); Yu YOSHIMURA, Tokyo (JP); Kazuki UEHARA, Tokyo (JP)

(21) Appl. No.: 17/820,014

(22) Filed: Aug. 16, 2022

(30) Foreign Application Priority Data
Aug. 18, 2021 (JP) 2021-133173

(51) Int. Cl. G05B 13/02

(52) U.S. Cl. CPC G05B 13/0265

(57) ABSTRACT

A training device includes at least one memory and at least one processor. The at least one processor is configured to train a model, which is related to a measured variable of a control object under, a constraint corresponding to a relationship between a change in a value of time series data as input data and a change in a value of time series data as ground truth data.

### CROSS-REFERENCE TO RELATED APPLICATIONS

This application is based upon and claims priority to Japanese Patent Application No. 2021-133173 filed on Aug. 18, 2021, the entire contents of which are incorporated herein by reference.

### BACKGROUND

### 1. Technical Field

The present disclosure may relate to training devices, plants, methods of generating a model, inference devices, inference methods, and methods of controlling a plant.

### 2. Description of the Related Art

In various types of plant control systems, model predictive control (MPC) is implemented by acquiring time-series sensor data indicative of information (for example, temperature, pressure, and the like) related to measured variables of a control object when actuators (for example, valves) are being operated, and modeling the control object based on the acquired information.

In the modeling of a control object, utilization of a model, such as a neural network (NN) model, which can infer the nonlinear behaviors of the control object is being explored. In the case of a model such as a neural network model, however, it is difficult to derive model parameters that have high generalizability in a situation where the training data are biased due to a lack of training data.

### SUMMARY

The present disclosure provides a training device capable of deriving a highly generalizable model for inferring information related to measured variables of a control object.

According to one aspect of the present disclosure, a training device includes at least one memory and at least one processor. The at least one processor is configured to train a model which is related to a measured variable of a control object under a constraint corresponding to a relationship between a change in a value of time series data as input data and a change in a value of time series data as ground truth data.

### BRIEF DESCRIPTION OF THE DRAWINGS

FIG. 1 is a diagram illustrating an example of the overall system configuration of a control system during a training phase;

FIG. 2 is a view illustrating an example of training data;

FIG. 3 is a block diagram illustrating the hardware configuration of a training device;

FIG. 4 is a first view illustrating an example of the functional configuration of a training unit;

FIG. 5 is a view illustrating a specific example of constraints imposed by a first training unit during a training process;

FIG. 6 is a flowchart illustrating the procedure of the training process;

FIG. 7 is a first view illustrating an example of the overall system configuration of the control system during an inference phase;

FIG. 8 is a first block diagram illustrating an example of the functional configuration of a model unit;

FIG. 9 is a first flowchart illustrating the procedure of an inference process;

FIG. 10 is a second view illustrating an example of the functional configuration of a training unit;

FIG. 11 is a second view illustrating an example of the overall system configuration of the control system during an inference phase;

FIG. 12 is a second block diagram illustrating an example of the functional configuration of a model unit;

FIG. 13 is a second flowchart illustrating an example of the procedure of an inference process; and

FIG. 14 is a third view illustrating an example of the functional configuration of a training unit.

### DETAILED DESCRIPTION

Embodiments of the present disclosure will be described hereinafter in detail with reference to the accompanying drawings. In the present specification and the drawings, components having substantially the same functional configuration will be denoted by the same reference signs, and a repetitive description thereof will be omitted.

### First Embodiment

<System Configuration of Control System During Training Phase>

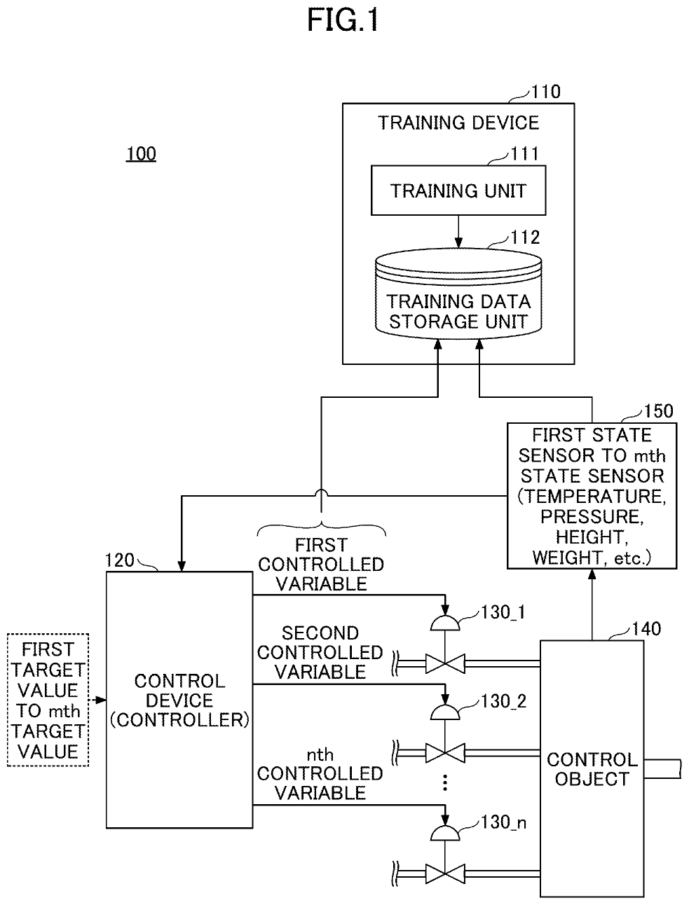

The overall system configuration of a control system that includes a training device (that is, the overall system configuration of a control system during a training phase) according to the first embodiment will be described first. FIG. 1 is a diagram illustrating an example of the overall system configuration of the control system during the training phase.

As illustrated in FIG. 1, during the training phase, a control system 100 may include a training device 110, a control device 120, valves 130_1 to 130_n, a control object 140, and state sensors 150.

A training program may be installed in the training device 110. Executing the training program may allow the training device 110 to function as a training unit 111.

The training unit 111 may include monotonically constrained models (to be described in detail later). By using training data stored in a training data storage unit 112, the training unit 111 may train each monotonically constrained model to update the model parameters of the monotonically constrained model.

The control device 120 may control, for example, the operations of the valves 130_1 to 130_n which serve as an example of actuators. More specifically, the control device 120 may acquire, from the state sensors 150 (a first state sensor to an mth [m is an integer of 2 or higher] state sensor that measure respective measured variables of the control object 140), respective sets of time series data (information related to the respective measured variables of the control object) as the measured variables of the control object 140. The control device 120 may also calculate a difference between each of the sets of the time series data, as the measured variables of the control object 140, and a corresponding one of first to mth target values which have been input in advance. Further, the control device 120 may output first to nth controlled variables to operate the valves 130_1 to 130_n, respectively, in accordance with the calculated differences.

Note that in this embodiment, the control device 120 may store the first to nth controlled variables as the training data in the training data storage unit 112 during the training phase.

The valves 130_1 to 130_n may operate based on the first to nth controlled variables which are output from the control device 120.

Various types of control items such as the temperature, the pressure, the height, the weight, and the like of the control object 140 may be controlled by the control device 120. The control object 140 may include, for example, tanks and treatment furnaces of various types of plants.

The “various types of plants” mentioned here may include, for example, petroleum refineries or petrochemical plants. In such cases, the control object 140 may include apparatuses for refining petroleum or manufacturing petrochemical products. Note that apparatuses for refining petroleum or manufacturing petrochemical products include, for example, at least one of an atmospheric distillation unit, a hydrotreating unit, a catalytic reforming unit, a catalytic cracking unit, a hydrocracking unit, or a desulfurization unit.

The control object 140 may also include other production equipment and industrial machinery. Alternatively, the control object 140 may also include a part, such as electric circuitry, of the equipment. Alternatively, the control object 140 may also include a specific network such a sensor network.

The control object 140 may also include various types of infrastructure facilities such as a water supply system, a smart grid, and the like. Alternatively, the control object 140 may also be various types of moving objects such as automobiles, robots, ships, planes, and the like.

The state sensors 150 may include the first to mth state sensors. The state sensors 150 may measure the measured variables (for example, the information related to the states of the control object 140) of the control object 140 to output respective sets of time series data as the measured variables of the control object 140. Note that during the training phase in this embodiment, the state sensors 150 may transmit m sets of time series data measured by the first to mth state sensors to the control device 120 as well as store the m sets of time series data as training data in the training data storage unit 112.

### Specific Example of Training Data

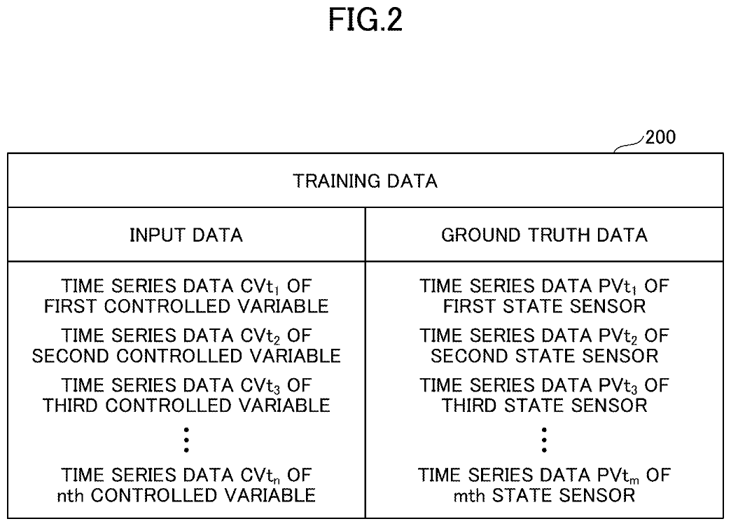

A specific example of the training data stored in the training data storage unit 112 will be described next. FIG. 2 is a view illustrating an example of the training data. As illustrated in FIG. 2, training data 200 may include “INPUT DATA” and “GROUND TRUTH DATA” as items of information.

“INPUT DATA” may store input data used by training unit 111 to train the monotonically constrained models. In this embodiment, the “INPUT DATA” may store sets of time series data CVt₁ to CVtₙ (information related to the control of the control object) of the first to nth controlled variables, respectively, which are transmitted from the control device 120.

“GROUND TRUTH DATA” may store ground truth data used by the training unit 111 to train the monotonically constrained models. In this embodiment, the “GROUND TRUTH DATA” may store sets of time series data PVt₁ to PVtₘ of the first to mth state sensors, respectively, which are transmitted from the state sensors 150.

<Hardware Configuration of Training Device>

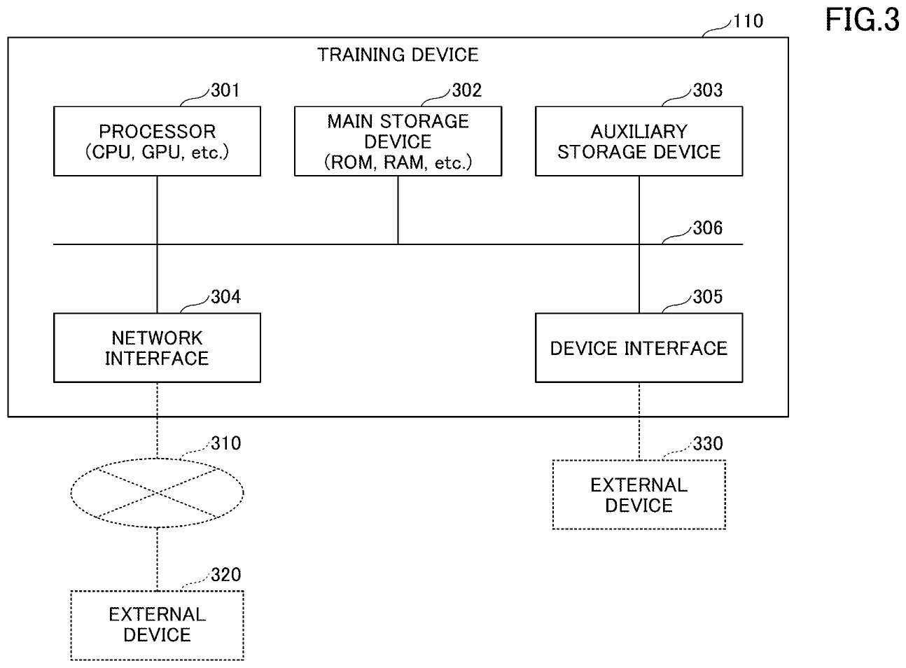

The hardware configuration of the training device 110 will be described next. FIG. 3 is a block diagram illustrating an example of the hardware configuration of the training device. As illustrated in FIG. 3, the training device 110 may include a processor 301, a main storage device (memory) 302, an auxiliary storage device 303, a network interface 304, and a device interface 305 as components. The training device 110 may be implemented as a computer in which these components are connected to each other via a bus 306.

Note that although the training device 110 is illustrated as including one unit of each component in the example of FIG. 3, the training device 110 may include a plurality of units of the same component. Further, although only one training device 110 is illustrated in the example of FIG. 3, a training program may be installed in one or more training devices such that the one or more training devices can execute the same processing operation or different processing operations of the training program. In such a case, a distributed computing configuration in which each of the training devices communicate with each other via the network interface 304 to execute the overall processing may be employed. That is, the training device 110 may be configured as a system that achieves a function by one or more computers executing instructions stored in one or more storage devices.

Alternatively, a configuration in which various data transmitted from the control device 120 and the state sensors 150 are processed by one or more training devices provided on a cloud and processing results are transmitted to a client inference device may be employed.

Parallel processing of various operations of the training device 110 may be executed by using one or more processors or by using a plurality of training devices that communicate via a communication network 310. The various operations may be assigned to multiple arithmetic cores provided in the processor 301 and may be executed by parallel processing. Some or all of the processes, means, and the like of the present disclosure may be executed by an external device 320 which is provided on a cloud that can communicate with, the training device 110 (at least either a processor or a storage device) through the communication network 310. In this manner, the training device 110 may have a configuration where parallel computing is performed by one or more computers.

The processor 301 may be an electronic circuit (for example, a processing circuit, processing circuitry, CPU, GPU, FPGA, or ASIC). The processor 301 may be a semiconductor device or the like that includes a dedicated processing circuit. Note that the processor 301 is not limited to an electronic circuit using electronic logic elements, but may be implemented by an optical circuit using optical logic elements. The processor 301 may have a computing function based on quantum computing.

The processor 301 may perform various operations based on various data and instructions which are input from devices provided internally as components in the training device 110, and may output operation results and control signals to the devices. The processor 301 may execute an operating system (OS), an application, or the like to control the components in the training device 110.

The processor 301 may refer to one or more electronic circuits provided on a single chip, or may refer to one or more electronic circuits provided on two or more chips or two or more devices. When using multiple electronic circuits for the processor 301, each electronic circuit may communicate by performing wired communication or wireless communication.

The main storage device 302 may be a storage device that stores various data and instructions executed by the processor 301, and the various data stored in the main storage device 302 may be read by the processor 301. The auxiliary storage device 303 may be a storage device other than the main storage device 302. Each of these storage devices may be any electronic component that can store various data, and may be a semiconductor memory. The semiconductor memory may be either a volatile memory or a non-volatile memory. The storage device that stores various data in the training device 110 may be implemented by the main storage device 302 or the auxiliary storage device 303, or may be implemented by an internal memory incorporated in the processor 301.

Additionally, the single processor 301 or the multiple processors 301 or may be connected (coupled) to the single main storage device 302. The multiple main storage devices 302 may be connected (coupled) to the single processor 301. If the training device 110 includes at least one main storage device 302 and the multiple processors 301 connected (coupled) to the at least one main storage device 302, a configuration in which at least one of the multiple processors 301 is connected (coupled) to the at least one main storage device 302 may be included. This configuration may also be achieved by the main storage device 302 and the processor 301 included in the multiple training devices 110. Further, a configuration in which the main storage device 302 is integrated into the processor (for example, a cache memory including an L1 cache, an L2 cache) may be included.

The network interface 304 may be an interface that connects to the communication network 310 by wireless or wired communication. An appropriate interface, such as an interface that conforms to an existing communication standard, may be used for the network interface 304. Various data may be exchanged by the network interface 304 with the control device 120 and the other devices such as the external device 320 which are connected via the communication network 310. Note that the communication network 310 may be any one or a combination of a wide area network (WAN), a local area network (LAN), a personal area network (PAN), or the like, as long as the network is used to exchange information between the computer and the control device 120 and the other devices such as the external device 320. An example of the WAN may be the Internet, an example of the LAN may be IEEE 802.11 or Ethernet, and an example of the PAN may be Bluetooth® or near field communication (NFC).

The device interface 305 may be an interface such as an USE that directly connects the training device 110 to an external device 330.

The external device 330 may be a device connected to a computer. The external device 330 may be, for example, an input device. The input device may be, for example, a camera, a microphone, a motion capture system, various sensors (including the state sensors 150), a keyboard, a mouse, a touch panel, or the like. The input device provides acquired information to the computer.

Alternatively, the input device may be a device, such as a personal computer, a tablet terminal, or a smartphone, which includes an input unit, a memory, and a processor.

The external device 330 may be, for example, an output device. The output device may be, for example, a loudspeaker that outputs sound or a display device such as a liquid crystal display (LCD), a cathode ray tube (CRT), a plasma display panel (PDP), or an organic electroluminescent (EL) panel. The output device may also be a device which includes an output unit, a memory, and a processor, such as a personal computer, a tablet terminal, or a smartphone.

The external device 330 may be a storage device (a memory). For example, the external device 330 may be a storage device such as a network storage. Alternatively, the external device 330 may be a storage device such as an HDD.

The external device 330 may be a device that has some of the functions of the components of the training device 110. That is, the computer may transmit or receive some or all of processing results of the external device 330.

<Functional Configuration of Training Unit>

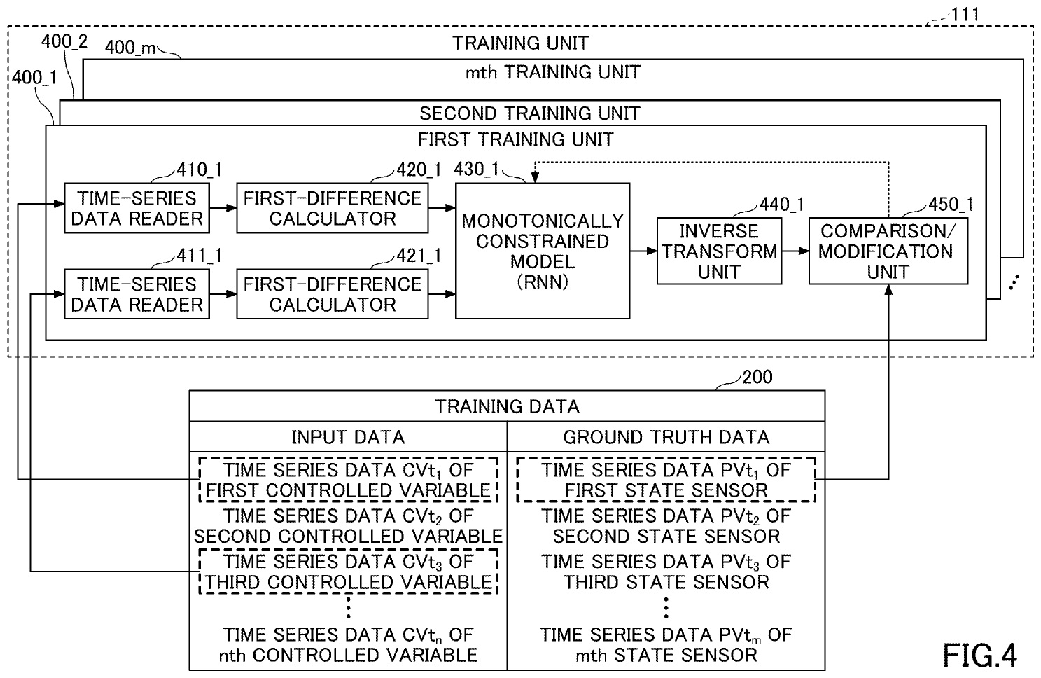

The functional configuration of the training unit 111 of the training device 110 will be described next. FIG. 4 is a first view illustrating an example of the functional configuration of the training unit.

As illustrated in FIG. 4, the training unit 111 may include a number of training units (that is, m training units) corresponding to the number of state sensors (m state sensors ranging from the first state sensor to the mth state sensor in this embodiment) included in the state sensors 150.

Note that since a first training unit 400_1 to an mth training unit 400_m may have the same configuration, the first training unit 400_1 will be described here.

As illustrated in FIG. 4, the first training unit 400_1 may include time-series data readers 410_1 and 411_1, first-difference calculators 420_1 and 421_1, a monotonically constrained model 430_1, an inverse transform unit 440_1, and a comparison/modification unit 450_1.

Each of the time-series data readers 410_1 and 411_1 may read the input data from the training data 200, and input the input data to the corresponding one of the first-difference calculators 420_1 and 421_1. The input data read by the time-series data readers 410_1 and 411_1 may be time series data of the controlled variables of the valves that affect the behavior of the “TIME SERIES DATA PVt₁ OF FIRST STATE SENSOR” which are processed as ground truth data in the first training unit 400_1.

In this embodiment, the valves 130_1 and 130_3 may be assumed to be the valves that affect the behavior of the “TIME SERIES DATA PVt₁ OF FIRST STATE SENSOR”. Hence, the time-series data reader 410_1 may read the “TIME SERIES DATA CVt₁ OF FIRST CONTROLLED VARIABLE” and output the time series data CVt₁ to the first-difference calculator 420_1, and the time-series data reader 411_1 may read the “TIME SERIES DATA CVt₃ of THIRD CONTROLLED VARIABLE” and output the time series data CVt₃ to the first-difference calculator 421_1.

The first-difference calculators 420_1 and 421_1 are an example of calculators. The first-difference calculator 420_1 may calculate the first difference from the time-series data of the controlled variable read by the time-series data reader 410_1, and the first-difference calculator 421_1 may calculate the first difference from the time-series data of the controlled variable read by the time-series data 411_1. Each of the first-difference calculators 420_1 and 421_1 may input the calculated first difference into the monotonically constrained model 430_1.

The monotonically constrained model 430_1 may be a model related to a measured variable of the control object and may be configured by, for example, a recurrent neural network (RNN). The monotonically constrained model 430_1 may receive, as inputs, the first-difference data of the “TIME SERIES DATA CVt₁ OF FIRST CONTROLLED VARIABLE” and the first-difference data of the “TIME SERIES DATA CVt₃ of THIRD CONTROLLED VARIABLE”, and output time series data as a model output.

The inverse transform unit 440_1 may inverse transform the time series data output from the monotonically constrained model 430_1. The inverse transform unit 440_1 may perform a process which is the inverse of the process for calculating the first difference of time series data. More specifically, the inverse transform unit 440_1 may transform the first-differenced time series data back to their original scale. The time series data inverse transformed by the inverse transform unit 440_1 may be input to the comparison/modification unit 450_1.

The comparison/modification unit 450_1 is an example of an updating unit. The comparison/modification unit 450_1 may read the “TIME SERIES DATA PVt₁ OF FIRST STATE SENSOR” from the “GROUND TRUTH DATA” of the training data 200. The comparison/modification unit 450_1 may compare the “TIME SERIES DATA PVt₁ OF THE FIRST STATE SENSOR” with the inverse-transformed time series data input from the inverse transform unit 440_1. The comparison/modification unit 450_1 may update the model parameters of the monotonically constrained model 430_1 based on the comparison result.

At this time, under each constraint corresponding to the relationship between the change in the value of the time series data of each controlled variable as the input data and the change in the value of the time series data of the state sensor as the ground truth data, the comparison/modification unit 450_1 may update each corresponding model parameter of the monotonically constrained model 430_1.

In the case of the first training unit 400_1, the model parameters of the monotonically constrained model 430_1 may be updated under the following constraints:
a constraint corresponding to the relationship between the change in the value of the “TIME SERIES DATA CVt₁ OF THE FIRST CONTROLLED VARIABLE” as the input data and the change in the value of the “TIME SERIES DATA PVt₁ OF THE FIRST STATE SENSOR” as the ground truth data; and
a constraint corresponding to the relationship between the change in the value of the “TIME SERIES DATA CVt₃ OF THE THIRD CONTROLLED VARIABLE” as the input data and the change in the value of the “TIME SERIES DATA PVt₁ OF THE FIRST STATE SENSOR” as the ground truth data.

Note that the relationship between the change in the value of the time series data of a controlled variable as the input data and the change in the value of the time series data of a state sensor as the ground truth data may include at least one of the following four relationships:
a monotonically increasing relationship in which the value of the time-series data of the state sensor, as the ground truth data, increases when the value of the time-series data of the controlled variable, as the input data, is increased;
a monotonically decreasing relationship in which the value of the time-series data of the state sensor, as the ground truth data, decreases when the value of the time-series data of the controlled variable, as the input data, is increased;
a zero-gain relationship in which the value of the time-series data of the state sensor, as the ground truth data, does not change when the value of the time-series data of the controlled variable, as the input data, has changed; or
a random relationship in which it is unknown whether the value of the time-series data of the state sensor, as the ground truth data, will change when the value of the time-series data of the controlled variable, as the input data, has changed.

If the change in the value of the time series data of a controlled variable as the input data and the change in the value of the time series data of the state sensor as the ground truth data have a monotonically increasing relationship, the comparison/modification unit 450_1 may impose, during the updating of each corresponding model parameter, a constraint such that each corresponding model parameter becomes a positive value.

If the change in the value of the time series data of a controlled variable as the input data and the change in the value of the time series data of the state sensor as the ground truth data have a monotonically decreasing relationship, the comparison/modification unit 450_1 may impose, during the updating of each corresponding model parameter, a constraint such that each corresponding model parameter becomes a negative value.

If the change in the value of the time series data of a controlled variable as the input data and the change in the value of the time series data of the state sensor as the ground truth data have a zero-gain relationship, the comparison/modification unit 450_1 imposes, during the updating of each corresponding model parameter, a constraint such that each corresponding model parameter becomes zero.

Note that a zero-gain relationship may be implemented by limiting the time series data read by each time-series data reader.

If the change in the value of the time series data of a controlled variable as the input data and the change in the value of the time series data of the state sensor as the ground truth data have a random relationship, the comparison/modification unit 450_1 may not impose a constraint during the updating of each corresponding model parameter.

### Specific Example of Constraints Imposed by Training Unit During Training Process

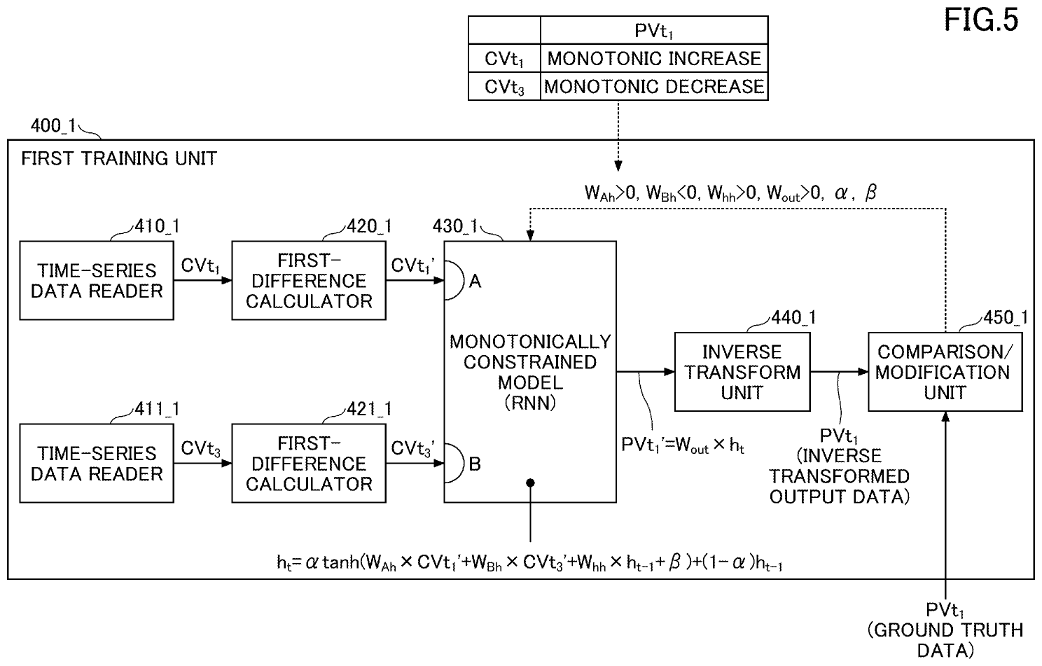

A specific example of the constraints imposed by the training unit during a training process will be described next. FIG. 5 is a block diagram illustrating an example of the constraints imposed by the first training unit during a training process.

As illustrated in FIG. 5, the time series data CVt₁ of the first controlled variable output from the time-series data reader 410_1 may be input to the first-difference calculator 420_1, and the time series data CVt₃ of the third controlled variable output from the time-series data reader 411_1 may be input to the first-difference calculator 421_1.

Further, first-difference data CVt₁′ and first-difference data CVt₃′ output from the first-difference calculators 420_1 and 421_1, respectively, may be input to the monotonically constrained model 430_1. In the monotonically constrained model 430_1, time-series data PVt₁′ as a model output may be output by inputting the first-difference data CVt₁′ and the first-difference data CVt₃′ into

hₜ=α tan h(W_{Ah}×CVt₁′+W_{Bh}×CVt₃′+Wₕₕ×hₜ₋₁+β)+(1−α)×hₜ₋₁ (1)

and calculating

PVt₁′=Wₒᵤₜ×hₜ (2)

where W_{Ah} is a model parameter of the first-difference data CVt₁′, W_{Bh} is a model parameter of the first-difference data CVt₃′, Wₕₕ is a model parameter of a previous value hₜ₋₁, α and β are coefficients, Wₒᵤₜ is a model parameter of a current value hₜ, and a subscript t=1, . . . , T.

The time series data PVt₁′ output from the monotonically constrained model 430_1 may be inverse transformed in the inverse transform unit 440_1. The inverse transform unit 440_1 may output the inverse-transformed time-series data PVt₁. The comparison/modification unit 450_1 may compare the inverse-transformed time series data PVt₁ and the time series data PVt₁ of the first state sensor as the ground truth data, and update the model parameters.

Here, the comparison/modification unit 450_1 may impose constraints as follows:
Both Wₕₕ and Wₒᵤₜ are constrained to be positive.
W_{Ah} is constrained to be positive (because the change in the value of the time series data CVt₁ of the first controlled variable and the change in the value of the time series data PVt₁ of the first state sensor have a monotonically increasing relationship as described above).
W_{Bh} is constrained to be negative (because the change in the value of the time series data CVt₃ of the third controlled variable and the change in the value of the time series data PVt₁ of the first state sensor have a monotonically decreasing relationship as described above).

Note that “constrained to be positive” indicates that, for example, when a model parameter is updated by gradient descent, the updated model parameter may remain a positive value if it is a positive value, but may be clipped to zero if it is a negative value. In addition, “constrained to be negative” indicates that, for example, when a model parameter is updated by gradient descent, the updated model parameter may remain a negative value if it is a negative value, but may be clipped to zero if it is a positive value.

Conventionally, in a system that satisfies monotonicity, a model with low generalizability is generated by calculating model parameters that violate monotonic constraints, and a model with even lower generalizability is generated in a situation where there is bias in the training data due to a lack of the training data. However, employing the first training unit 400_1 may allow such problems to be avoided by imposing the above-described constraints based on monotonicity. More specifically, employing the first training unit 400_1 may allow the monotonically constrained model 430_1 that has high generalizability and can infer the time series data of the first state sensor to be implemented.

<Procedure of Training Process>

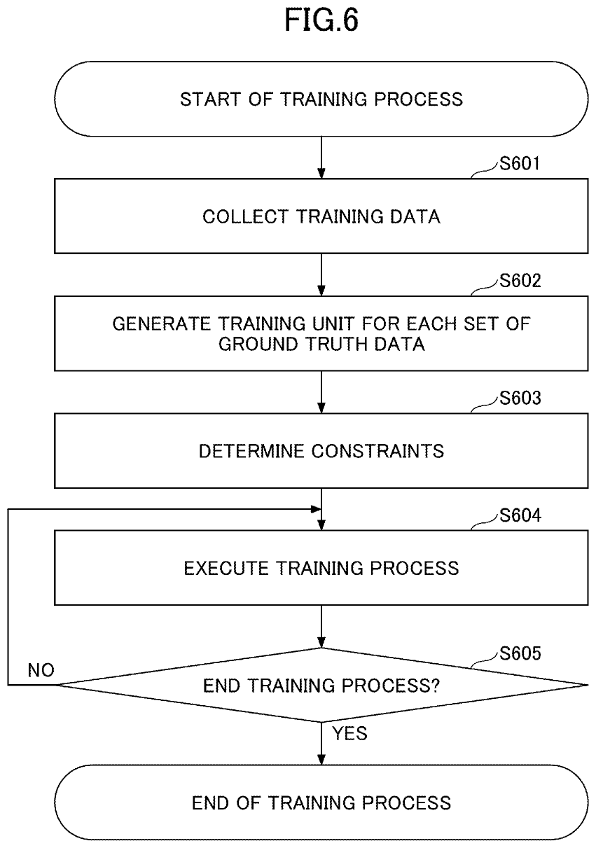

The procedure of a training process by the training device 110 will be described next. FIG. 6 is a flowchart illustrating the procedure of the training process.

In step S601, the training device 110 collects the training data 200.

In step S602, by generating a training unit for each set of ground truth data included in the training data 200, the training device 110 generates training units for training a number of monotonically constrained models corresponding to the number of sets of ground truth data.

In step S603, based on the relationships between the respective changes in the values of the time series data as the input data and the respective changes in the values of the time series data as the ground truth data included in the training data 200, the training device 110 determines the constraints to be imposed in the updating of model parameters.

In step S604, the training device 110 reads the training data 200 and executes a training process under the determined constraints to generate trained monotonically constrained models.

In step S605, the training device 110 determines whether to end the training process. If it is determined in step S605 that the training process is to be continued (NO in step S605), the process may return to step S604.

On the other hand, if it is determined in step S605 that the training process is to be ended (YES in step S605), the training process may end.

<System Configuration of Control System During Inference Phase>

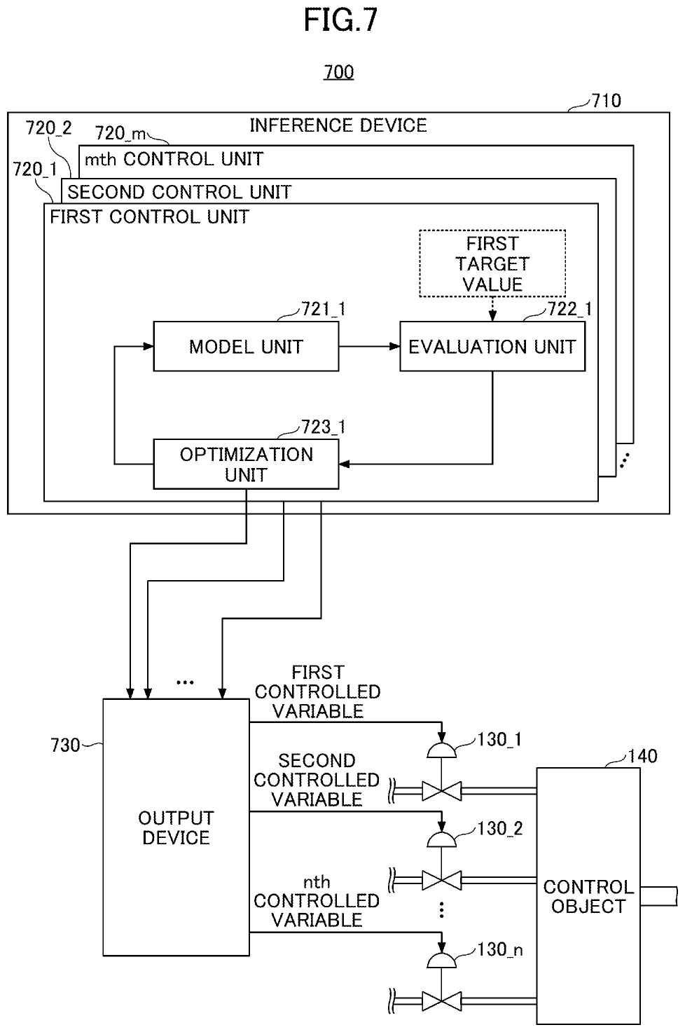

The overall system configuration of a control system including an inference device (that is, the overall system configuration of a control system during an inference phase) according to the first embodiment will be described next. FIG. 7 is a first view illustrating an example of the overall system configuration of a control system during an inference phase.

As illustrated in FIG. 7, during an inference phase, a control system 700 may include an inference device 710, an output device 730, the valves 130_1 to 130_n, and the control object 140.

An inference program may be installed in the inference device 710. Executing the inference program may cause the inference device 710 to function as a first control unit 720_1 to an mth control unit 720_m.

Note that since the first training unit 720_1 to the mth training unit 720_m may have the same configuration, the functional configuration of the first training unit 720_1 will be described here.

The first control unit 720_1 may include a model unit 721_1, an evaluation unit 722_1, and an optimization unit 723_1.

The model unit 721_1 may include a trained monotonically constrained model and use the trained monotonically constrained model to infer the time series data of the first state sensor.

The evaluation unit 722_1 may evaluate the difference between the first target value (the target value of the first state sensor) and the time series data of the first state sensor inferred by the model unit 721_1, and may notify the optimization unit 723_1 of the evaluation result.

The evaluation unit 722_1 may calculate the time series data of the first controlled variable and the time series data of the third controlled variable so as to maximize the evaluation result (so as to minimize the difference) provided from the evaluation unit 722_1, and may input the calculation result into the model unit 721_1. The optimization unit 723_1 may repeat the process (inference→evaluation→input) until the evaluation result provided from the evaluation unit 722_1 reaches a maximum value. Furthermore, at the point when the evaluation result provided from the evaluation unit 722_1 has reached the maximum value, the time series data of the first controlled variable and the time series data of the third controlled variable may be output as the optimized time series data of the first controlled variable and the optimized time series data of the third controlled variable to the output device 730. For example, the optimization unit 723_1 may optimize the time series data of the first controlled variable and the time series data of the third controlled variable by back-propagating errors between the inferred time series data of the first state sensor and the target value of the first state sensor.

The output device 730 may acquire the optimized time series data of the first controlled variable to the optimized time series data of the controlled variable n which are transmitted from the first control unit 720_1 to the mth control unit 720_m, respectively, of the inference device 710. The output device 730 may also transmit the time series data of the first controlled variable to the time series data of the controlled variable n which have been acquired to the valve 130_1 to the valve 130_n, respectively. As a result, the valve 130_1 to the valve 130_n may operate based on the respective controlled variables optimized by the first control unit 720_1 to the mth control unit 720_m.

<Functional Configuration of Model Unit Included in Each Control Unit>

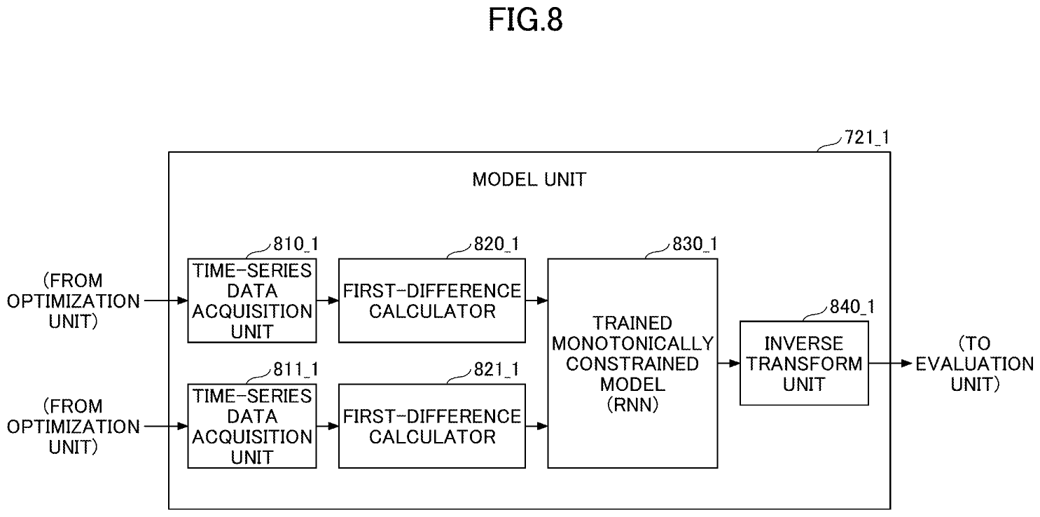

Among the respective model units included in the first control unit 720_1 to the mth control unit 720_m, the functional configuration of the model unit 721_1 included in the first control unit 720_1 will be described next. FIG. 8 is a first view illustrating an example of the functional configuration of the model unit.

As illustrated in FIG. 8, the model unit 721_1 may include time-series data acquisition units 810_1 and 811_1, first-difference calculators 820_1 and 821_1, a trained monotonically constrained model 830_1, and an inverse transform unit 840_1.

The time-series data acquisition unit 810_1 may acquire, from the optimization unit 723_1, the calculated time series data of the first controlled variable, and input the acquired times series data of the first controlled variable into the first-difference calculator 820_1. The time-series data acquisition unit 811_1 may acquire, from the optimization unit 723_1, the calculated time series data of the third controlled variable, and input the acquired time series data of the third controlled variable into the first-difference calculator 821_1.

The first-difference calculators 820_1 and 821_1 are an example of calculators. The first-difference calculator 820_1 may calculate the first difference of the time series data of the first controlled variable input from the time-series data acquisition unit 810_1. The first-difference calculator 821_1 may calculate the first difference of the time series data of the third controlled variable input from the time-series data acquisition unit 811_1. The first-difference calculators 820_1 and 821_1 may each input the calculated first-difference data into the trained monotonically constrained model 830_1.

Based on the first-difference data of the time series data of the first controlled variable and the first-difference data of the time series data of the third controlled variable input from the first-difference calculators 820_1 and 821_1, respectively, the trained monotonically constrained model 830_1 may calculate first-differenced time series data as a model output.

The inverse transform unit 840_1 may inverse transform the first-differenced time series data as the model output, which has been output from the trained monotonically constrained model 830_1, to calculate the time series data of the first state sensor. The inverse transform unit 840_1 may notify the evaluation unit 722_1 of the calculated time series data of the first state sensor.

As a result, by employing the model unit 721_1, the trained monotonically constrained model 830_1 that has high generalizability may be used to infer the time series data (measured variables of the control object) of the first state sensor.

<Procedure of Inference Process>

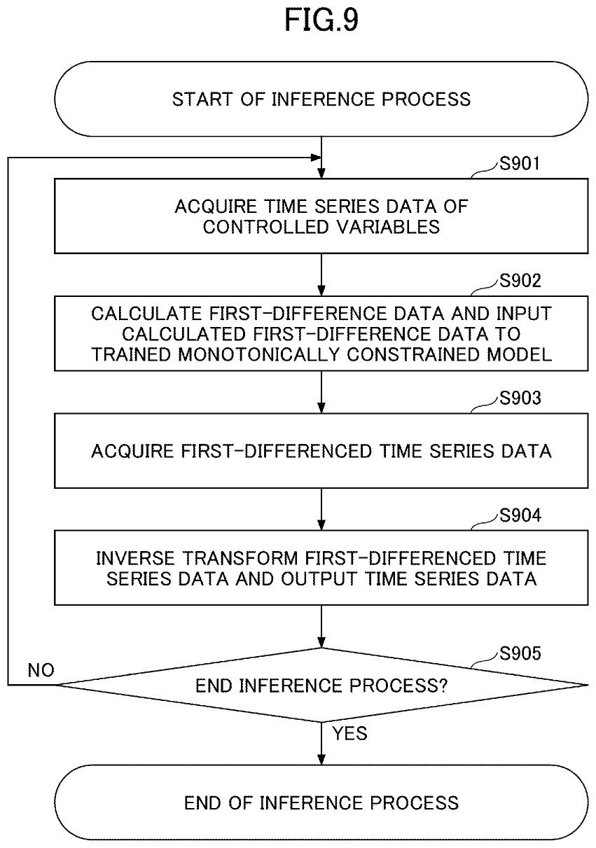

The procedure of an inference process by the model unit of each control unit of the inference device 710 will be described next. FIG. 9 is a first flowchart illustrating the procedure of the inference process.

In step S901, the model unit of each control unit of the inference device 710 acquires the respective time series data of controlled variables which have been calculated by the optimization unit.

In step S902, the model unit of each control unit of the inference device 710 calculates the first difference of the acquired time series data of each controlled variable to calculate the first-difference data of the time series data of the controlled variable. The model unit of each control unit of the inference device 710 inputs each set of the calculated first-difference data into the trained monotonically constrained model.

In step S903, the model unit of each control unit of the inference device 710 acquires the first-differenced time series data as the model output which is output from the trained monotonically constrained model.

In step S904, the model unit of each control unit of the inference device 710 inverse transforms the first-differenced time series data to infer the measured variable of the control object. The model unit of each control unit of the inference device 710 also outputs the inferred measured variable of the control object.

In step S905, the model unit of each control unit of the inference device 710 determines whether to end the inference process (for example, whether the evaluation result of the measured variable of the control object has reached a maximum value). If it is determined in step S905 that the inference process is to be continued (NO in step S905), the process may return to step S901.

On the other hand, if it is determined in step S905 that the inference process is to be ended (YES in step S905), the inference process may end.

<Summary>

As is obvious from the above description, the training device 110 according to the first embodiment may include a plurality of training units for training a number of monotonically constrained models corresponding to a number of state sensors which measure the measured variables of a control object. When each of the plurality of training units trains a monotonically constrained model, each training unit may update each model parameter of the monotonically constrained model under a constraint corresponding to a relationship (a monotonically increasing relationship, a monotonically decreasing relationship, a zero-gain relationship, or a random relationship) between a change in the value of the time series data of each controlled variable which is input and a change in the value of the time series data of a state sensor which is output.

Therefore, the training device 110 according to the first embodiment may implement monotonically constrained models that have high generalizability and can infer the measured variables of a control object.

In addition, the inference device 710 according to the first embodiment may include a plurality of model units corresponding to the number of state sensors for measuring the measured variables of the control object. Each model unit may include a trained monotonically constrained model which has been trained by a corresponding training unit. In each trained monotonically constrained model, each model parameter may be updated under a constraint corresponding to a relationship between the change in the value of the time series data input to the corresponding training unit and the change in the value of the time series data output from the corresponding training unit. Each model unit may use the trained monotonically constrained model to infer the time series data of the measured variable of the control object.

Therefore, the inference device 710 according to the first embodiment may use the trained monotonically constrained models that have high generalizability to infer the measured variables of the control object.

### Second Embodiment

In the configuration according to the first embodiment described above, a number of training units corresponding to a number of state sensors for measuring the measured variables of a control object are provided, and each training unit includes a monotonically constrained model which is trained under predetermined constraints.

In the configuration according to the second embodiment, models which are trained without predetermined constraints may be provided in addition to the monotonically constrained models which are trained under predetermined constraints. According to the second embodiment, such a configuration may compensate for the loss in the expressiveness of each monotonically constrained model due to the constraints during the training process. The second embodiment will be described hereinafter by focusing on the differences from the first embodiment described above.

<Functional Configuration of Training Unit>

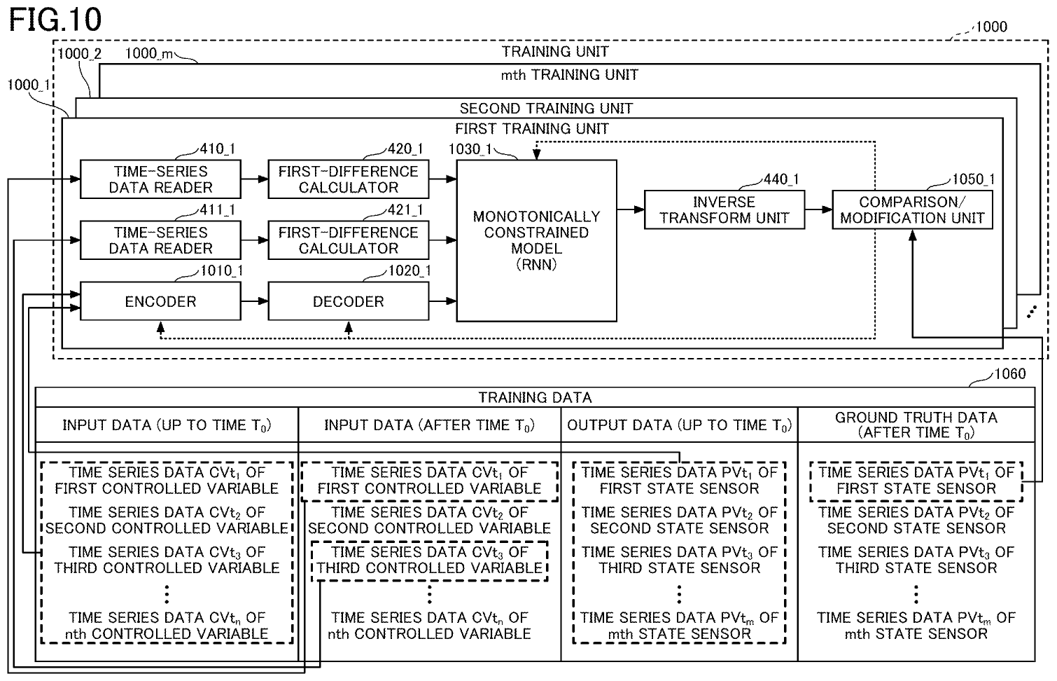

The functional configuration of a training unit of a training device according to the second embodiment will be described first. FIG. 10 is a second view illustrating an example of the functional configuration of the training unit.

As illustrated in FIG. 10, a training unit 1000 may include a number of training units corresponding to a number of state sensors included in state sensors 150.

Note that in a similar manner to the case described above with reference to FIG. 4 in the first embodiment, a first training unit 1000_1 to mth training unit 1000_m may have the same configuration. Hence, the first training unit 1000_1 will be described here. Furthermore, to simplify the description, differences from the first training unit 400_1 illustrated in FIG. 4 will be mainly described.

A difference from the first training unit 400_1 illustrated in FIG. 4 is that the first training unit 1000_1 of FIG. 10 may include an encoder 1010_1 and a decoder 1020_1. Furthermore, in the case of the first training unit 1000_1 of FIG. 10, the function of a monotonically constrained model 1030_1 differs from the function of the monotonically constrained model 4301 of FIG. 4, and the function of a comparison/modification unit 1050_1 differs from the function of the comparison/modification unit 450_1 of FIG. 4.

As “INPUT DATA” of training data 1060, the time series data of all controlled variables acquired in a period up to a reference time T₀ may be input to the encoder 1010_1. In addition, as “OUTPUT DATA” included in the training data 1060, the time series data of all state sensors acquired in a period up to the reference time T₀ may be input to the encoder 1010_1. That said, the time series data of only some of the controlled variables among the controlled variables acquired as the “INPUT DATA” of training data 1060 in a period up to the reference time T₀ may be input to the encoder 1010_1. Additionally, the time series data of only some of the state sensors among the time series data of the state sensors acquired as the “OUTPUT DATA” of training data 1060 in a period up to the reference time T₀ may be input to the encoder 1010_1.

Note that the training data 1060 may be basically the same as the training data 200. However, in the training data 1060, the “INPUT DATA” of the training data 200 of FIG. 2 have been divided into “INPUT DATA (UP TO TIME T₀)” and “INPUT DATA (AFTER TIME T₀)”. In the case of the training data 1060, among the time series data of the controlled variables, the time series data of the controlled variables acquired in the period up to the reference time T₀ may be stored in the “INPUT DATA (UP TO TIME T₀)”. Also, in the case of the training data 1060, among the time series data of the state sensors, the time series data of the controlled variables acquired after the reference time T₀ may be stored in the “INPUT DATA (AFTER TIME T₀)”.

In a similar manner, in the training data 1060, “GROUND TRUTH DATA” of the training data 200 of FIG. 2 have been divided into “OUTPUT DATA (UP TO TIME T₀)” and “GROUND TRUTH DATA (AFTER TIME T₀)”. In the case of the training data 1060, among the time series data of the state sensors, the time series data of the state sensors acquired in the period up to the reference time T₀ may be stored in the “OUTPUT DATA (UP TO TIME T₀)”. Also, in the case of the training data 1060, among the time series data of the state sensors, the time series data of the state sensors acquired after the reference time T₀ may be stored in the “GROUND TRUTH DATA (AFTER TIME T₀)”.

Note that the time series data of all of (or some of) the controlled variables acquired in the period up to the reference time T₀ and stored in the “INPUT DATA (UP TO TIME T₀)” and the time series data of all of (or some of) the state sensors acquired in the period up to the reference time T₀ and stored in the “OUTPUT DATA (UP TO TIME T₀)” may be in random relationships with respect to monotonicity.

By receiving the time series data of all (or some of) the controlled variables acquired in the period up to the reference time T₀ and the time series data of all of (or some of) the state sensors acquired in the period up to the reference time T₀, the encoder 1010_1 may output data representing the hidden state at the reference time T₀.

The decoder 1020_1 may receive the data representing the hidden state at the reference time T₀ which were output from the encoder 1010_1, and output the time series data representing the hidden states after time T₀.

The monotonically constrained model 1030_1 may output the time series data as a model output by receiving, as input data, the first-difference data of “TIME SERIES DATA CVₜ₁ OF FIRST CONTROLLED VARIABLE” (after time T₀), the first-difference data of “TIME SERIES DATA CVₜ₁ OF THIRD CONTROLLED VARIABLE” (after time T₀), and the time series data representing the hidden states after time T₀.

The comparison/modification unit 1050_1 may read “TIME SERIES DATA PVt₁ OF FIRST STATE SENSOR” from the “GROUND TRUTH DATA (AFTER TIME T₀)” of the training data 1060 and compare the “TIME SERIES DATA PVₜ₁ OF FIRST STATE SENSOR” with the inverse transformed time series data input from an inverse transform unit 440_1. The comparison/modification unit 1050_1 may update the model parameters of the monotonically constrained model 1030_1, the model parameters of the encoder 1010_1, and the model parameters of the decoder 1020_1.

Here, in the comparison/modification unit 1050_1, the model parameters of the monotonically constrained model 1030_1 may be updated under constraints corresponding to the relationship between the change in the value of the time series data of the controlled variables as the input data (after time T₀) and the change in the value of the time series data of the state sensors as the ground truth data (after time T₀).

The comparison/modification unit 1050_1 may also update the model parameters of the encoder 1010_1 and the model parameters of the decoder 1020_1 without imposing the constraints described above.

Therefore, the first training unit 1000_1 may, in addition to implementing the monotonically constrained model 1030_1 that has high generalizability and can infer the time series data of the first state sensor, compensate the loss in expressiveness of the monotonically constrained model 1030_1 due to constraints during the training process.

<System Configuration of Control System During Inference Phase>

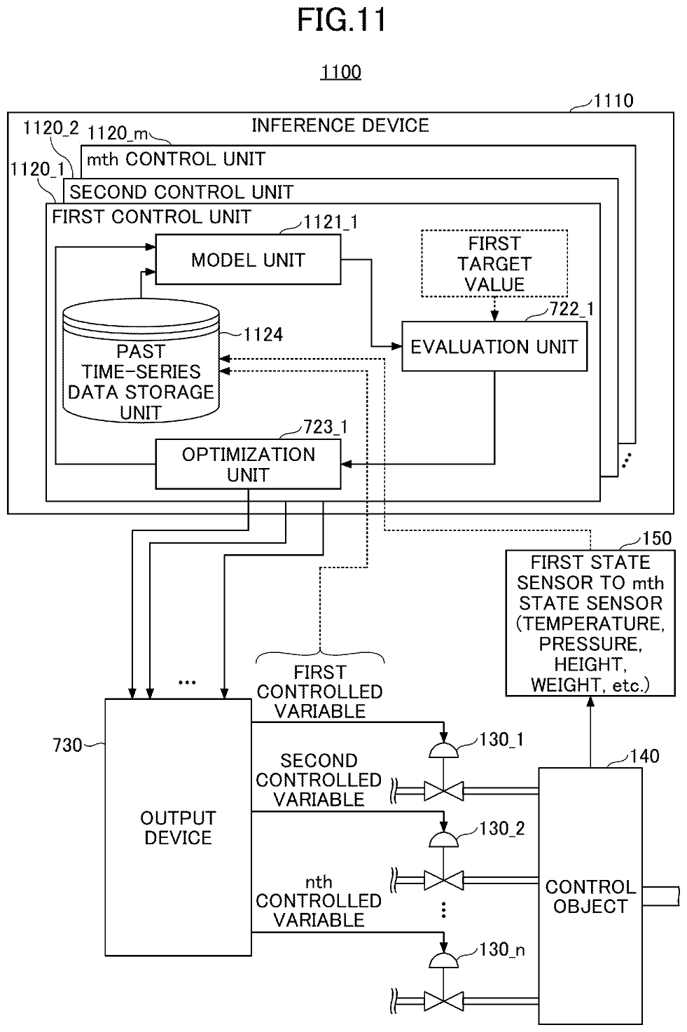

The overall system configuration of a control system including an inference device according to the second embodiment (that is, the overall system configuration of the control system in the inference phase) will be described next. FIG. 11 is a second view illustrating an example of the overall system configuration of the control system in the inference phase.

As illustrated in FIG. 11, a control system 1100 may include an inference device 1110, an output device 730, valves 130_1 to 130_n, a control object 140, and the state sensors 150. Since the output device 730, the valves 130_1 to 130_n, the control object 140, and the state sensors 150 have already been described in the first embodiment, a description of these components will be omitted here.

Also, since a first control unit 1120_1 to an mth control unit 1120_m may have the same functional configuration, the functional configuration of the first control unit 1120_1 will be described here.

The first control unit 1120_1 may include a model unit 1121_1, an evaluation unit 722_1, and an optimization unit 723_1.

The model unit 1121_1 may include a trained monotonically constrained model. The following data may be input to the model unit 1121_1:
the time series data of controlled variables calculated by the optimization unit 723_1; and
the time series data of all of the controlled variables and time series data of all of the state sensors (which may be the time series data of all of the controlled variables and the time series data of all of the state sensors within a predetermined time range from the current time to a past time) read by a past time-series data storage unit 1124.

Note that the time series data of only some of the controlled variables and the time series data of only some of the state sensors read by the past time-series data storage unit 1124 may be input to the model unit 1121_1. Note that “the time series data of only some of the controlled variables and the time series data of only some of the state sensors” may be the time series data of some of the controlled variables and the time series data of some of the state sensors that fall within a predetermined time range from the current time to a past time. The “predetermined time range” here refers to a time range equal to a time range of input data or output data in a period up to the reference time T₀ included in the training data 1060.

Therefore, the model unit 11211 may use the trained monotonically constrained model to infer the time series data of the time sensor 1.

<Functional Configuration of Model Unit Included in Each Control Unit>

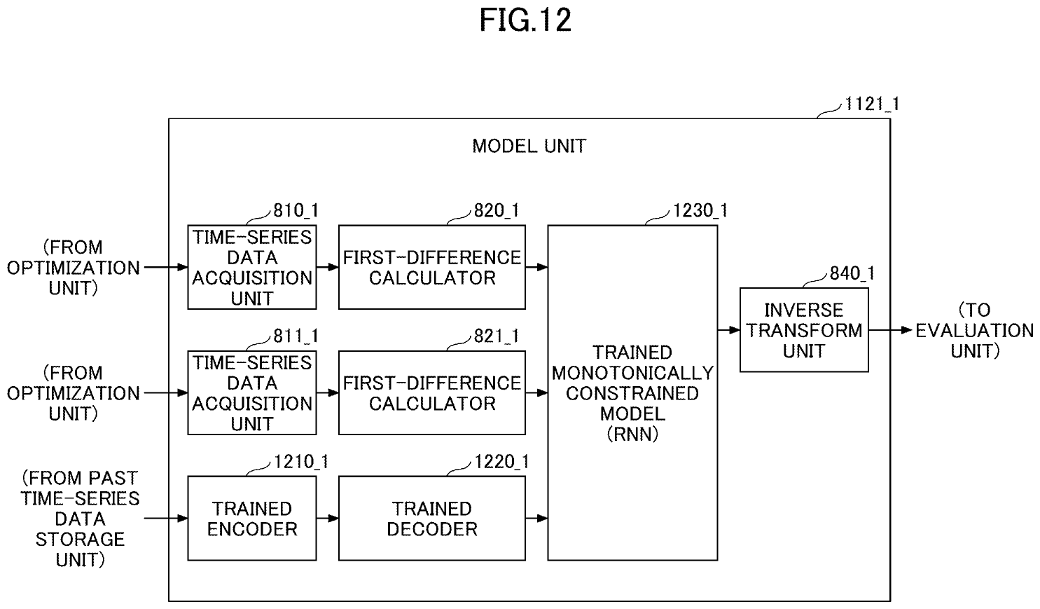

Among the respective model units included in the first control unit 1120_1 to the mth control unit 1120_m, the functional configuration of the model unit 1121_1 included in the first control unit 1120_1 will be described next. FIG. 12 is a second view illustrating an example of the functional configuration of the model unit.

As illustrated in FIG. 12, the model unit 1121_1 may include time-series data acquisition units 810_1 and 811_1, first-difference calculators 820_1 and 821_1, a trained encoder 1210_1, and a trained decoder 1220_1. The model unit 1121_1 may also include a trained monotonically constrained model 1230_1, and an inverse transform unit 840_1.

Note that since the time-series data acquisition units 810_1 and 811_1 and the first-difference calculators 820_1 and 821_1 have already been described above with reference to FIG. 8 in the first embodiment, a description of these components will be omitted here.

The trained encoder 1210_1 may read the time series data of all of (or some of) the controlled variables and the time series data of all of (or some of) the state sensors that are stored in the past time-series data storage unit 1124 and fall within a predetermined time range from the current time to a past time. By receiving, as the input data, the time series data of all of (or some of) the controlled variables and the time series data of all of (or some of) the state sensors that fall within a predetermined time range from the current time to a past time, the trained encoder 1210_1 may output data representing the hidden state at the current time.

By receiving the data representing the hidden state at the current time which are input from the trained encoder 1210_1, the trained decoder 1220_1 may calculate the time series data representing the hidden states at times after the current time. Subsequently, the trained decoder 1220_1 may input the calculated time-series data representing the hidden states into the trained monotonically constrained model 12301.

The trained monotonically constrained model 1230_1 may calculate the first-differenced time series data based on the following data:
the first-difference data of the time series data of the first controlled variable input from the first-difference calculator 820_1 and the first-difference data of the time series data of the third controlled variable input from the first-difference calculator 821_1; and
the time series data that are input from the trained decoder 1220_1 and represent the hidden state at a time after the current time.

Therefore, the model unit 1121_1 may use the trained monotonically constrained model 1230_1, which has high generalizability, and the trained encoder 1210_1 and the trained decoder 1220_1, which compensate the expressiveness of the trained monotonically constrained model 1230_1, to infer the time series data of the first state sensor.

<Procedure of Inference Process>

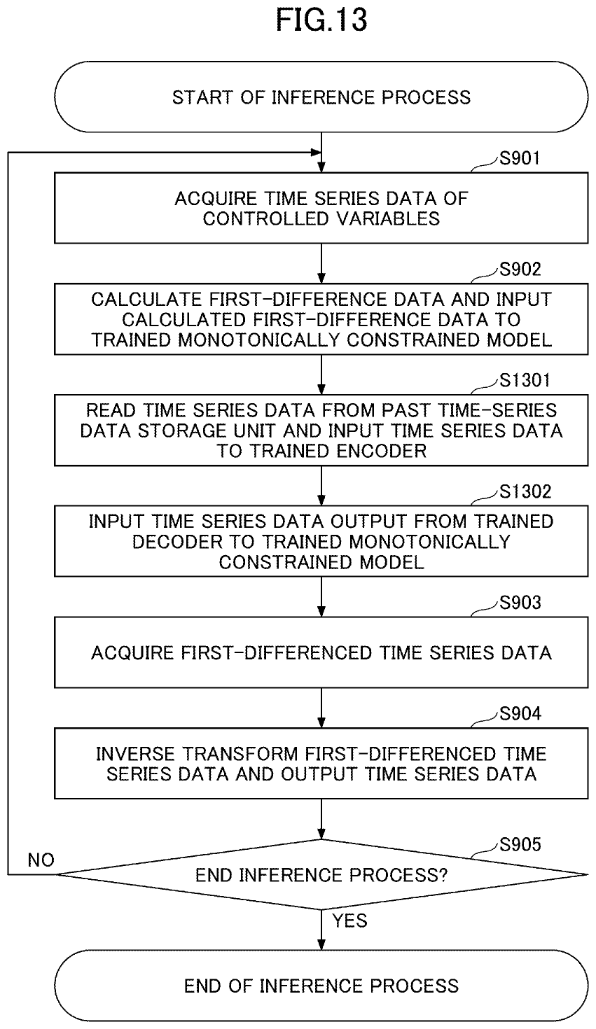

The procedure of the inference process by the model unit of each control unit of the inference device 1110 will be described next. FIG. 13 is a second flowchart of the procedure of the inference process. Processes of step S1301 and S1302 differ from the procedure of the first flowchart described with reference to FIG. 9.

In step S1301, the model unit of each control unit of the inference device 1110 acquires the time series data from the past time-series data storage unit 1124. More specifically, the model unit of each control unit of the inference device 1110 acquires the time series data of all of (or some of) the controlled variables and the time series data of all of (or some of) the state sensors that fall within a predetermined time range from the current time to a past time. The model unit of each control unit of the inference device 1110 also inputs the acquired time-series data into the trained encoder.

In step S1302, the model unit of each control unit of the inference device 1110 inputs the time series data, which have been output from the trained decoder and represent the hidden states at times after the current time, into the trained monotonically constrained model.

<Summary>

As is obvious from the above description, the training device 110 according to the second embodiment may include a plurality of training units for training a number of monotonically constrained models corresponding to a number of state sensors which measure the measured variables of a control object. Each of the plurality of training units may include, additionally, an encoder and a decoder which calculate, from the time series data acquired in period up to a reference time, the time series data representing a hidden state at a time after the reference time. When each of the plurality of training units trains a monotonically constrained model, each model parameter of the monotonically constrained model may be updated under a constraint corresponding to a relationship between a change in the value of the time series data of each controlled variable which are input and a change in the value of the time series data of a corresponding state sensor which are output. When each of the plurality of training units trains the encoder and the decoder, the model parameters of the encoder and the model parameters of the decoder may be updated without the constraints.

Therefore, the training device 110 according to the second embodiment may, in addition to implementing monotonically constrained models that have high generalizability and can infer the measured variables of the control object, compensate the loss in expressiveness of each monotonically constrained model due to constraints during the training process.

Further, in the inference device 1110 according to the second embodiment, each of a number of model units corresponding to the number of state sensors may include a trained monotonically constrained model which has been trained by a corresponding training unit. Each model parameter of each trained monotonically constrained model may be updated under a constraint corresponding to a relationship between a change in the value of the time series data input to the training unit and a change in the value of the time series data output from the training unit. Each model unit may further include a trained encoder and a trained decoder that have been trained by the corresponding training unit. The model parameters of the trained encoder and the model parameters of the trained decoder may be updated without the constraints corresponding to the relationship between the change in the value of the time series data input to the training unit and the change in the value of the time series data output from the training unit. Each model unit may use the trained monotonically constrained model, the trained encoder, and the trained decoder to infer the time series data as the measured variable of the control object.

Therefore, the inference device 1110 according to the second embodiment may infer the measured variables of the control object by using the trained monotonically constrained models, which have high generalizability, and the trained encoders and the trained decoders, which compensate the expressiveness of the trained monotonically constrained models.

### Third Embodiment

The above first and second embodiments described cases where each monotonically constrained model may be trained such that the trained monotonically constrained model outputs the first-differenced time series data as the model output. The third embodiment will describe a case where each monotonically constrained model may be trained such that the trained monotonically constrained model outputs time series data with no differencing as the model output. The third embodiment will be described hereinafter by focusing on the differences from the first and second embodiments described above.

<Functional Configuration of Training Unit>

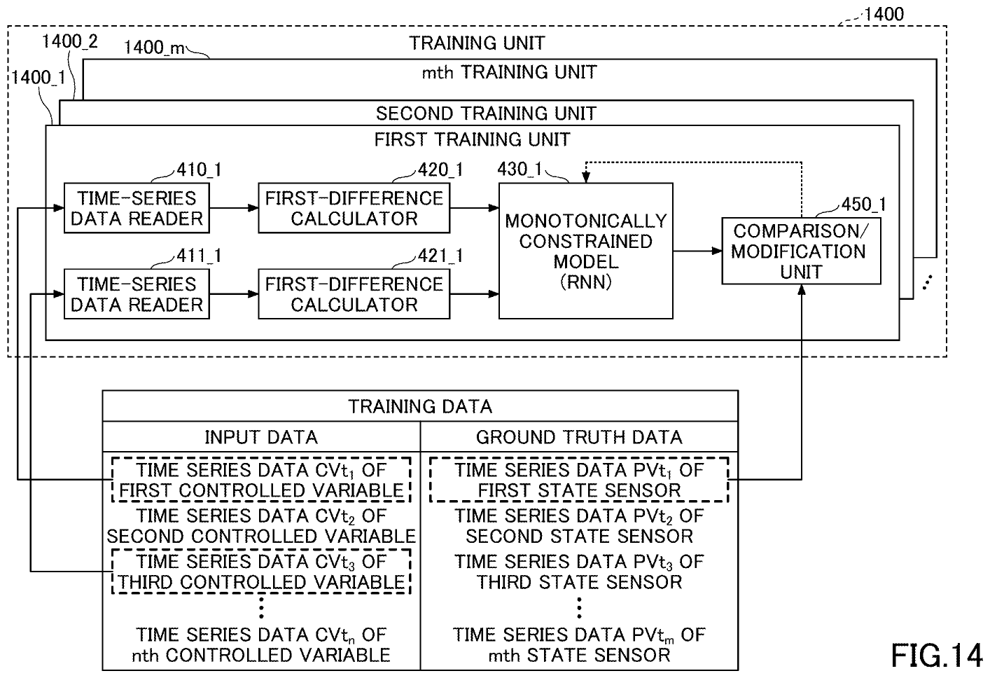

The functional configuration of a training unit of a training device 110 according to the third embodiment will be described first. FIG. 14 is a third view illustrating an example of the functional configuration of a training unit. A difference from the training unit 111 described with reference to FIG. 4 in the first embodiment is that, in the case of a training unit 1400 of FIG. 14, each of a first training unit 1400_1 to an mth training unit 1400_m may not include an inverse transform unit.

Hence, for example, in a comparison/modification unit 450_1, time series data output from a monotonically constrained model 430_1 and time series data PVt₁ of a first state sensor may be compared, and the model parameters of the monotonically constrained model 430_1 may be updated based on the comparison result. That is, the monotonically constrained model 430_1 may be trained to output the time-series data with no differencing as a model output.

As a result, for example, even in a control system configured to allow the difference of first-difference data output from each of a first-difference calculator 420_1 and a first-difference calculator 421_1 to decrease gradually with the elapse of time, it may be possible to implement an effective trained monotonically constrained model.

### SUMMARY

As is obvious from the above description, the training device 110 according to the third embodiment may include a plurality of training units for training a number of monotonically constrained models corresponding to a number of state sensors which measure the measured variables of a control object. When each of the plurality of training units trains a monotonically constrained model, each model parameter of the monotonically constrained model may be updated under a constraint corresponding to a relationship between a change in the input value of the time series data of each controlled variable and a change in the output value of the time series data of the corresponding state sensor. When updating the model parameters, each of the plurality of training units may update each model parameter of the monotonically constrained model based on a result acquired by comparing the time series data as a model output of the monotonically constrained model and the time series data of the state sensor as the ground truth data of the training data.

Therefore, in a similar manner to the first embodiment, the training device 110 according to the third embodiment may implement monotonically constrained models which have high generalizability, and implement trained monotonically constrained models which are effective regardless of the characteristics of the control system.

### Fourth Embodiment

In the above-described embodiments, when a model parameter is “constrained to be positive”, the updated model parameter may be clipped to zero if the value of the updated model parameter is negative. However, the constraining method when a model parameter is “constrained to be positive” is not limited to this. For example, a model parameter may be “constrained to be positive” by defining the model parameter as W_{Ah}=+exp(W_{Ah}′).

In a similar manner, in the above-described embodiments, when a model parameter is “constrained to be negative”, the updated model parameter may be clipped to zero if the value of the updated model parameter is positive. However, the constraining method when a model parameter is “constrained to be negative” is not limited to this. For example, a model parameter may be “constrained to be negative” by defining the model parameter as W_{Bh}=−exp(W_{Bh}′).

Further, the above-described embodiments did not describe a method for determining which of the four relationships is applicable to the relationship between the change in the value of the time series data as the input data and the change in the value of the time series data as the ground truth data. However, the method of determining the applicability of the four relationships may be employed in a discretionary manner, and may be determined based on, for example, the knowledge of an expert. Alternatively, a simulation of a step response may be executed at multiple step sizes on a simulator, and the applicability of the four relationships may be determined based on the final gain at the time.

Further, the above-described embodiments described that the monotonically constrained model may be formed by RNN. However, the monotonically constrained model is not limited to RNN and may be formed by another architecture. The monotonically constrained model may be formed by using a neural network (NN) to model the temporal change in the output time series data without discretizing t in the manner of, for example, Neural ODE.

Furthermore, the above-described embodiments ensured monotonicity by imposing constraints on the signs of the model parameters. However, the method of ensuring monotonicity is not limited to this. For example, monotonicity may be ensured by using a method disclosed in the following literature:
Deep Lattice Networks and Partial Monotonic Functions (NeurIPS 2017) (https://arxiv.org/abs/1709.06680)
Certified Monotonic Neural Networks (NeurIPS 2020) (https:/arxiv.org/abs/2011.10219)

In addition, the above-described embodiments were described by using valves as an example of actuators that affect the measured variables of the control object 140. However, the actuators are not limited to valves.

Furthermore, the above-described embodiments used the time series data of the controlled variables acquired during automated control by the control device 120. However, the time series data of the controlled variables used as the input data are not limited to the time series data of the controlled variables acquired during automatic control. For example, time series data of controlled variables acquired during manual control by an operator may also be used as the input data.

### Other Embodiments

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-bb, and a-a-b-b-c-c. Further, the addition of another element other than the listed elements (i.e., a, b, and c), such as adding d as a-b-c-d, is included.

In the present specification (including the claims), if the expression such as “data as an input”, “based on data”, “according to data”, or “in accordance with data” (including similar expressions) is used, unless otherwise noted, a case in which various data themselves are used as an input and a case in which data obtained by processing various data (e.g., data obtained by adding noise, normalized data, and intermediate representation of various data) are used as an input are included. If it is described that any result can be obtained “based on data”, “according to data”, or “in accordance with data”, a case in which the result is obtained based on only the data are included, and a case in which the result is obtained affected by another data other than the data, factors, conditions, and/or states may be included. If it is described that “data are output”, unless otherwise noted, a case in which various data themselves are used as an output is included, and a case in which data obtained by processing various data in some way (e.g., data obtained by adding noise, normalized data, and intermediate representation of various data) are used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general-purpose processor, the processor may have a hardware configuration that can perform the operation B and be configured to actually perform the operation B by setting a permanent or temporary program (i.e., an instruction). If the element A is a dedicated processor or a dedicated arithmetic circuit, a circuit structure of the processor may be implemented so as to actually perform the operation B irrespective of whether the control instruction and the data are actually attached.

In the present specification (including the claims), if a term indicating containing or possessing (e.g., “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, states, and/or the like are satisfied, and is not necessarily obtained in the claimed invention that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in all of the embodiments described above, numerical values or mathematical expressions used for description are presented as an example and are not limited to them. Additionally, the order of respective operations in the embodiment is presented as an example and is not limited thereto.

What is claimed is:

1. A training device comprising:
at least one memory; and
at least one processor,
wherein the at least one processor is configured to train a model related to a measured variable of a control object under a constraint corresponding to a relationship between a change in a value of time series data as input data and a change in a value of time series data as ground truth data.

2. The training device as claimed in claim 1, wherein the at least one processor is configured to train, under the constraint, a plurality of models related to a plurality of measured variables of the control object.

3. The training device as claimed in claim 2, wherein the plurality of measured variables include information measured by a plurality of sensors, and
wherein the at least one processor is configured to train, for each of the plurality of sensors, a corresponding one of the plurality of models related to the plurality of measured variables of the control object.

4. The training device as claimed in claim 1, wherein the at least one processor is configured to calculate a first difference of the time series data as the input data, and
acquire time series data as a model output by inputting the first difference of the time series data into the model related to the measured variable of the control object.

5. The training device as claimed in claim 4, wherein the at least one processor is configured to inverse transform the time series data as the model output, and
train, under the constraint and based on a result of comparing the inverse transformed time series data as the model output and the time series data as the ground truth data, the model related to the measured variable of the control object.

6. The training device as claimed in claim 4, wherein the at least one processor is configured to train, under the constraint and based on a result of comparing the time series data as the model output and the time series data as the ground truth data, the model related to the measured variable of the control object.

7. The training device as claimed in claim 5, wherein the at least one processor is configured to input, into an encoder, time series data, which is acquired in a period up to a reference time among the time series data as the input data, and time series data, which is acquired in the period up to the reference time among the time series data as the ground truth data, to acquire time series data representing a hidden state at the reference time, and
input, into a decoder, the time series data representing the hidden state at the reference time, to acquire time series data representing a hidden state at a time after the reference time,
wherein the model related to the measured variable of the control object is configured to output the time series data as the model output by further receiving the time series data representing the hidden state at the time after the reference time, and
wherein the at least one processor is configured to train the encoder and the decoder without the constraint.

8. The training device as claimed in claim 1, wherein the time series data as the input data includes information related to control of the control object, and
wherein the time series data as the ground truth data includes information related to the measured variable of the control object.

9. The training device as claimed in claim 1, wherein the relationship between the change in the value of the time series data as the input data and the change in the value of the time series data as the ground truth data includes at least one of
a monotonically increasing relationship where the value of the time series data as the ground truth data increases when the value of the time series data as the input data is increased,
a monotonically decreasing relationship where the value of the time series data as the ground truth data decreases when the value of the time series data as the input data is increased, or
a zero-gain relationship where the value of the time series data as the ground truth data does not change even when the value of the time series data as the input data has changed.

10. The training device as claimed in claim 9, wherein the at least one processor is configured to impose, when the relationship between the change in the value of the time series data as the input data and the change in the value of the time series data as the ground truth data is the monotonically increasing relationship, the constraint such that a value of a model parameter of the model related to the measured variable of the control object becomes positive,
impose, when the relationship between the change in the value of the time series data as the input data and the change in the value of the time series data as the ground truth data is the monotonically decreasing relationship, the constraint such that the value of the model parameter of the model related to the measured variable of the control object becomes negative, and
impose, when the relationship between the change in the value of the time series data as the input data and the change in the value of the time series data as the ground truth data is the zero-gain relationship, the constraint such that the value of the model parameter of the model becomes zero.

11. A plant configured to execute control by using the model related to the measured variable of the control object trained by the training device of claim 1.

12. An inference device comprising:
at least one memory; and
at least one processor,
wherein the at least one processor is configured to infer, by using a model, information related to a measured variable of a control object, and
wherein the model has been trained under a constraint corresponding to a relationship between a change in a value of time series data as input data and a change in a value of time series data as ground truth data.

13. The inference device as claimed in claim 12, wherein the at least one processor is configured to use a plurality of models to infer information related to a plurality of measured variables of the control object, and
wherein each of the plurality of models has been trained under the constraint.

14. The inference device as claimed in claim 13, wherein the plurality of the models include a plurality of pieces of information which are measured by a plurality of sensors, and
wherein each of the plurality of models has been trained with respect to a corresponding one of the plurality of the sensors.

15. The inference device as claimed in claim 12, wherein the at least one processor is configured to calculate a first difference of the time series data as the input data, and
input the first difference of the time series data to the model to infer the information related to the measured variable of the control object.

16. The inference device as claimed in claim 15, wherein the at least one processor is configured to inverse transform time series data as a model output which is acquired by inputting the first difference of the time series data in the model, and
output, as the information related to the measured variable of the control object, the inverse transformed time-series data as the model output.

17. The inference device as claimed in claim 15, wherein the at least one processor is configured to output, as the information related to the measured variable of the control object, time series data as a model output which is acquired by inputting the first difference of the time series data to the model.

18. The inference device as claimed in claim 12, wherein the time series data as the input data includes the information related to the control of the control object, and
wherein the time series data as the ground truth data includes the information related to the measured variable of the control object.

19. The inference device as claimed in claim 12, wherein the relationship between the change in the value of the time series data as the input data and the change in the value of the time series data as the ground truth data includes at least one of
a monotonically increasing relationship where the value of the time series data as the ground truth data increases when the value of the time series data as the input data is increased,
a monotonically decreasing relationship where the value of the time series data as the ground truth data decreases when the value of the time series data as the input data is increased, or
a zero-gain relationship where the value of the time series data as the ground truth data does not change even when the value of the time series data as the input data has changed.

20. An inference method executed by at least one processor, the inference method comprising:
using a model to infer information related to a measured variable of a control object,
wherein the model has been trained under a constraint corresponding to a relationship between a change in a value of time series data as input data and a change in a value of time series data as ground truth data.
